(19) United States
(12) Patent Application Publication
(10) Pub. No.: US 2026/0061378 A1
(43) Pub. Date: Mar. 5, 2026

(54) MIXING DEVICE FOR SOLUTION AND POWDER PRECIPITATE

(71) Applicant: ANI.CO.LTD, Suwon-si (KR)

(72) Inventors: Dong Chul JEON, Seongnam-si (KR); Kyu ho LEE, Uiwang-si (KR); Seong Jin CHOI, Hwaseong-si (KR); Jae Suk YOON, Suwon-si (KR); Je Yeun LEE, Suwon-si (KR); Young Geun LIM, Hwaseong-si (KR)

(73) Assignee: ANI.CO.LTD, Suwon-si (KR)

(21) Appl. No.: 19/292,921

(22) Filed: Aug. 7, 2025

(30) Foreign Application Priority Data
Sep. 2, 2024 (KR) 10-2024-0118501

(51) Int. Cl. B01F 29/33; B01F 23/53; B01F 29/10; B01F 29/34

(52) U.S. Cl. CPC B01F 29/333; B01F 23/53; B01F 29/10; B01F 29/34

(57) ABSTRACT

A mixing device includes: a guide module which has a preset length, to which the mixing container is rotatably seated along a longitudinal direction and to which the mixing container is selectively fixed to be attachable and detachable; a rotating module which is provided on the guide module and selectively rotates the mixing container so that a first rotation axis is formed along the vertical direction of the mixing container; and a tilting module which is formed long along the vertical direction, has a second rotation axis on both sides along a width direction of the guide module, is rotatably coupled, and selectively rotates the guide module in the vertical direction to tilt the mixing container in a direction intersecting the first rotation axis.

### CROSS-REFERENCE TO RELATED APPLICATION

This application claims the benefit of priority under 35 U.S.C. § 119(a) to Korean Patent Application No. 10-2024-0118501 filed on Sep. 2, 2024, the entire contents of which are incorporated herein by reference.

### BACKGROUND

### (a) Technical Field

The present invention relates to a mixing device for solution and powder precipitate, and more particularly, to a mixing device for solution and powder precipitate that can stably mix and shorten a mixing time by rotating a mixing container containing the solution and powder precipitate around two rotation axes.

### (b) Background Art

In general, the mixing device is a device that puts two or more raw materials into a container and mixes them using an agitator, and is mainly used when mixing raw materials with different components from each other.

As a mixing type for such a mixing device, a type is applied in which raw materials with different components are put into a tank or container with a certain volume and then mixed by artificial or mechanical operation.

Here, a device that usually mixes contents by a vortex type is configured in a form that includes a main body having a cylindrical volume with a closed top, an injection port formed on an upper side face of the main body, a motor connected to a center of an upper end face of the main body, and a number of stirring blades connected onto a motor shaft and rotatably installed inside the main body to stir the contents.

However, in the case of such a structure, the contents inside the container cannot be sealed, which may lead to problems such as the inflow of foreign matter from the outside and occurrence of contamination, making it difficult to apply to precision fields such as chemistry and biology.

Therefore, there is a need to develop a technology that can stably mix the contents inside the container in the state of sealing the interior of the container and suppress the occurrence of precipitation.

### SUMMARY OF THE DISCLOSURE

The present invention has been devised to solve the problems of the related art described above, and provides a mixing device that can mix the contents of a mixing container by rotating it simultaneously with two rotating shafts, after sealing the mixing container to stably mix the contents consisting of a solution and a powder.

The problems of the present invention are not limited to the above-described problems, and other problems that are not described may be obviously understood by those skilled in the art from the following description.

The present invention to achieve the above object relates to a mixing device which rotates a mixing container that is formed long along a vertical direction and has a decreasing circumference at an upper end to mix contents contained therein, the mixing device including: a guide module which has a preset length, to which the mixing container is rotatably seated along a longitudinal direction and to which the mixing container is selectively fixed to be attachable and detachable; a rotating module which is provided on the guide module and selectively rotates the mixing container so that a first rotation axis is formed along the vertical direction of the mixing container; and a tilting module which is formed long along the vertical direction, has a second rotation axis on both sides along a width direction of the guide module, is rotatably coupled, and selectively rotates the guide module in the vertical direction to tilt the mixing container in a direction intersecting the first rotation axis.

In addition, the guide module may include a frame unit that is formed long along the longitudinal direction of the mixing container with a preset length and wraps a part of a side face of the mixing container; a rotating support unit that is provided on the other end of the frame unit, and comes into contact with and supports a lower face of the mixing container; and an upper support unit which is provided at one end of the frame unit, wraps a part of the circumference of the mixing container, and comes into contact with and supports an upper part along the longitudinal direction.

In addition, the upper support unit may have elasticity in a direction of the rotating support unit and provide sliding application with a pressure of a certain level.

In addition, the rotating support unit may be formed in a disk shape, provided on the other side of the frame unit, come into contact with the lower face of the mixing container, and may be coupled to be rotatable about the first rotation axis.

In addition, the upper support unit may include: a pressing support unit which is formed in an annular shape, protrudes from one side face of the frame unit, and is formed so that the upper part of the mixing container is seated at a center; and a plurality of rotating roller units which are disposed to be spaced apart along the annular shape of the pressing support unit, and come into contact with the upper end of the mixing container.

In addition, the rotating module may be provided on the frame unit, have a rotation axis parallel to the first rotation axis, and rotate the mixing container.

In addition, the mixing container may have a circular periphery on a side face, and the rotating module may be formed long along the longitudinal direction of the frame unit, have a rotation axis parallel to the first rotation axis, and come into contact with the side face of the mixing container and rotate the mixing container.

In addition, the rotating module may include a plurality of driving units disposed to be spaced apart along the width direction of the frame unit, at least one of which selectively rotates to provide a rotational force, and a rotating unit in which the remaining unit except for the driving unit is in a free rotating state.

In addition, the tilting module may rotate the guide module back and forth along the vertical direction within a preset range of rotation angles.

In addition, the tilting module may include a sensing unit which is provided on at least one of both sides along the width direction of the guide module, and detects whether the rotation angle deviates the preset range when the guide module rotates around the second rotation axis.

In addition, the guide module may further comprise a separate vibration generating unit that impacts the mixing container at regular intervals to generate vibrations.

In addition, the plurality of guide modules may be provided continuously along the second rotation axis, interconnected, and configured to be operable simultaneously, and the rotating module may be provided independently for each guide module and the mixing container is seated.

The mixing device of the present invention for solving the above problems includes a guide module to which the mixing container is seated, a rotating module that rotates the mixing container, and a tilting module that tilts the guide module up and down, which has an advantage of suppressing the occurrence of defects when mixing and shortening the mixing time, by rotating the mixing container in two directions to mix the contents.

In addition, the tilting module includes a separate sensing unit and detects whether the guide module tilts up and down within a preset rotation angle range, and if the guide module deviates from this range, the sensing unit can stop driving to prevent a safety accident from occurring.

The effects of the present invention are not limited to the above-described effects, and other effects that are not described may be obviously understood by those skilled in the art from the claims.

### BRIEF DESCRIPTION OF DRAWINGS

FIG. 1 is a diagram schematically illustrating a configuration of a mixing device according to an embodiment of the present invention.

FIG. 2 is a diagram illustrating the front of the mixing device of FIG. 1.

FIG. 3 is a diagram illustrating a configuration of a guide module in the mixing device of FIG. 1.

FIG. 4 is a diagram illustrating a state in which a mixing container is mounted to the guide module of FIG. 3.

FIG. 5 is a diagram illustrating a state in which the mixing device of FIG. 1 is switched from an initial state to a usage state, and the mixing container tilts at a certain angle.

FIG. 6 is a diagram illustrating a state in which the rotating module in the mixing device of FIG. 1 operates to rotate the mixing container.

FIG. 7 is a diagram illustrating a state in which the guide module in the mixing device of FIG. 1 tilts in a vertical direction.

FIG. 8 is a diagram illustrating a limit stopper inside the tilting module in the mixing device of FIG. 1.

FIG. 9 is a diagram illustrating the configuration of a sensing unit in the mixing device of FIG. 1.

FIG. 10 is a diagram illustrating a state in which a plurality of guide modules are configured in the mixing device according to the present invention.

### DETAILED DESCRIPTION

In this specification, when a component (or a region, a layer, a portion, etc.) is said to be “located on,” “connected,” or “coupled” to another component, it means that the component may be directly disposed/connected/coupled onto the other component, or a third component may be disposed between them.

The same drawing symbols refer to the same components. Furthermore, in the drawings, thicknesses, ratios, and dimensions of the components are exaggerated for the effective description of the technical content.

The term “and/or” includes one or more combinations in which the related configuration can be defined.

Although the terms such as first and second can be used to describe various components, the components should not be limited by the terms. The terms are used only for the purpose of distinguishing one component from another. For example, the first component can be named the second component, and similarly the second component can be named the first component, without departing from the scope of the present invention. A singular expression includes a plural expression unless the context clearly indicates otherwise.

In addition, the terms such as “under”, “below”, “up”, and “above” are used to describe association of the components shown in the drawings. The above described terms are relative concepts and are described on the basis of the directions shown in the drawings.

Unless otherwise defined, all terms (including technical and scientific terms) used in this specification have the same meaning as commonly understood by those skilled in the art to which the present invention pertains. Furthermore, the terms such as terms defined in commonly used dictionaries should be interpreted as having a meaning consistent with the meaning in the context of the relevant art, and are expressly defined in this specification unless interpreted in an ideal or overly formal sense.

It should be understood that terms such as “include” or “have” are intended to specify the presence of features, numbers, steps, operations, components, parts or combinations thereof described in the specification, but do not preclude the presence or addition of one or more other features or numbers, steps, operations, components, parts or combinations thereof.

Hereinafter, the embodiment of the present invention will be described in detail with reference to the drawings.

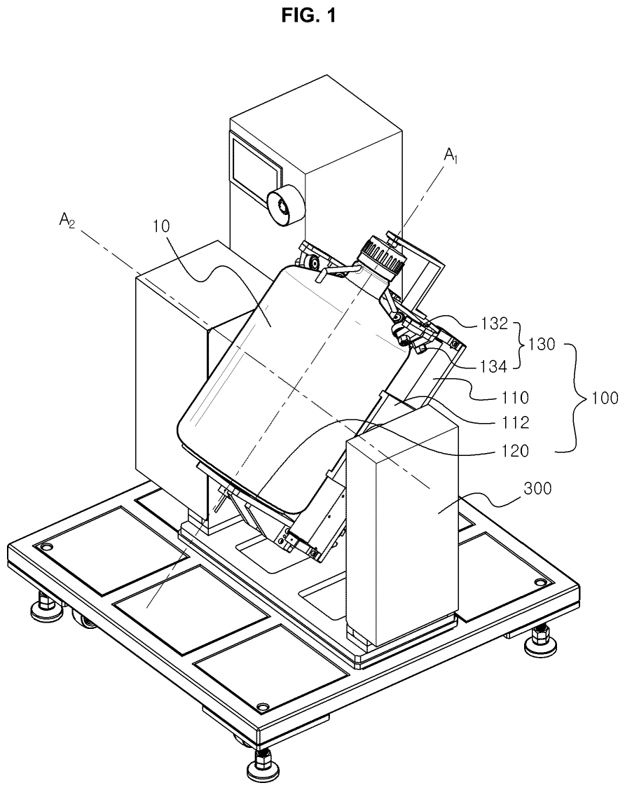

First, a configuration of a mixing device according to the present invention will be schematically described with reference to FIGS. 1 to 5.

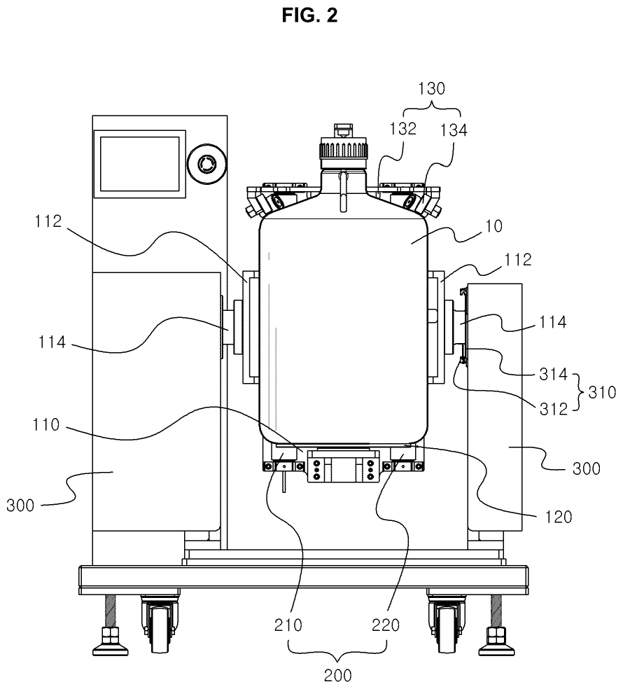

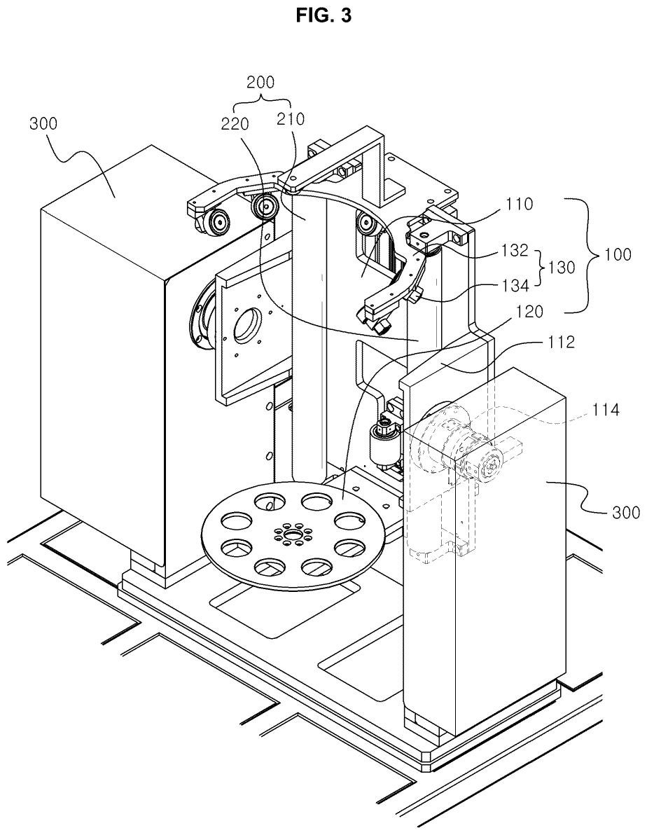

FIG. 1 is a diagram schematically illustrating a configuration of the mixing device according to an embodiment of the present invention, FIG. 2 is a diagram illustrating the front of the mixing device of FIG. 1, and FIG. 3 is a diagram illustrating a configuration of a guide module in the mixing device of FIG. 1.

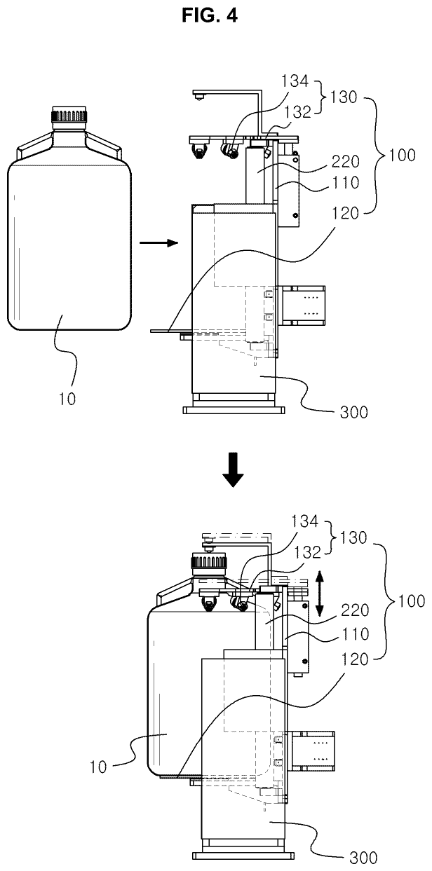

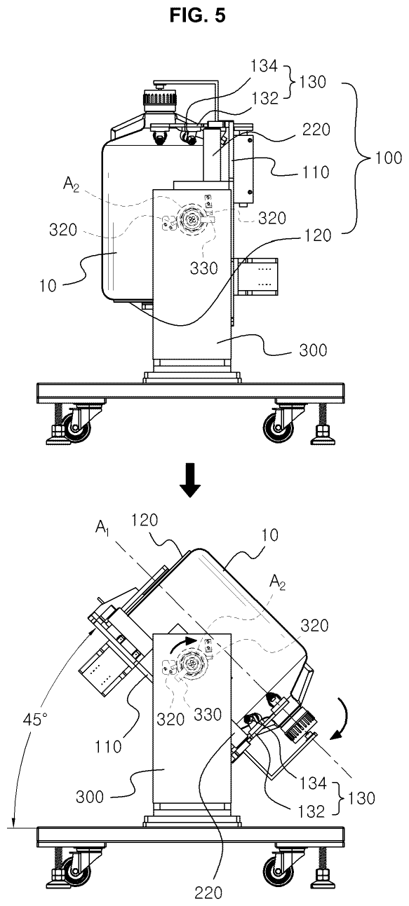

FIG. 4 is a diagram illustrating a state in which a mixing container is mounted to the guide module of FIG. 3, and FIG. 5 is a diagram illustrating a state in which the mixing device of FIG. 1 is switched from an initial state to a usage state and the mixing container tilts at a certain angle.

The present invention is a device for mixing a solution and powder precipitate contained inside in a packed state of a bio-refining process under optimal conditions. The solution and powder are contained inside a mixing container 10 and mixed through swinging and rolling in a sealed state.

Specifically, the present invention mainly includes a guide module 100, a rotating module 200, and a tilting module 300, and the mixing container 10 containing the contents rotates and tilts while seated to the guide module 100 to mix the contents.

The guide module 100 is formed long with a preset length, and the mixing container 10 is rotatably seated along a longitudinal direction. In this case, the guide module 100 is fixed so that the mixing container 10 is seated and rotates around a first rotation axis A1 formed along the longitudinal direction.

Here, the mixing container 10 is formed long along the vertical direction, and the mixing container 10 formed with a reduced circumference of an upper end is rotated so that the contents contained therein are mixed.

The guide module 100 is configured so that the mixing container 10 is seated and can be rotated without being detached by being pressed up and down along the longitudinal direction.

The detailed configuration of the guide module 100 includes a frame unit 110, a rotating support unit 120, and an upper support unit 130 that form a skeleton.

The frame unit 110 is formed long along the longitudinal direction of the mixing container 10 with a preset length, and is configured to wrap a part of the side face of the mixing container 10. Specifically, in the present invention, the frame unit 110 is formed long and is formed in a U-shape with both sides bent forward along a width direction, and both sides along the width direction are rotatably coupled to the tilting module 300 to be described later.

The mixing container 10 is seated at the center of the frame unit 110, and the rotating module 200 is further provided inside the frame unit 110.

In this embodiment, the frame unit 110 is formed long along the longitudinal direction as shown, and bent parts 112 bent on both sides along the width direction forward are formed, and the mixing container 10 is seated between the bent parts 112. The other end is bent forward along the longitudinal direction to support the lower part of the mixing container 10.

In other words, the frame unit 110 is formed long along the vertical direction, and both sides along the width direction and the lower part along the longitudinal direction are bent forward so that the mixing container 10 can be seated thereon.

Furthermore, the bent part 112 is formed with a rotating shaft 114 protruding along the width direction, and is rotatably coupled to the tilting module 300 to be described later with a second rotation axis A2.

On the other hand, the rotating support unit 120 is provided at the other end of the frame unit 110 and supported at the bottom of the mixing container 10.

Specifically, the frame unit 110 is formed in a plate shape with a certain area, comes into contact with the bottom face of the mixing container 10, and supports it so as not to detach. In this case, the frame unit 110 is coupled to the frame unit 110 so as to be rotatable around the first rotation axis A1 located at the center along the vertical direction of the mixing container 10.

That is, the frame unit 110 is configured to come into contact with the bottom face of the mixing container 10, support it at the lower part, and to be rotatable together with the mixing container 10 around the first rotation axis A1.

In this embodiment, the rotating support unit 120 is formed in a disk shape, is disposed in a form protruding from the other end of the frame unit 110, and is configured to rotate around the first rotation axis A1. In this case, the frame unit 110 is bent so that the other end protrudes forward as shown, and the rotating support unit 120 is configured to rotate at the protruding portion with the first rotation axis A1.

The upper support unit 130 is provided at one end of the frame unit 110, wraps around a part of the periphery of the mixing container 10, and comes into contact with and supports the upper part along the longitudinal direction. Specifically, the upper support unit 130 is disposed to face the rotating support unit 120 and supports the upper part of the mixing container 10, and is configured to allow stable rotation without interference when the mixing container 10 rotates.

That is, the mixing container 10 is seated to the frame unit 110, and the upper support unit 130 and the rotating support unit 120 are brought into contact with each other at the upper part and the lower part, and are seated between them.

In this case, the upper support unit 130 has elasticity in the direction of the rotating support unit 120, and slides and presses with a pressure of a certain level, and the elasticity allows the mixing container 10 to maintain a stable seated state without being detached.

Here, the upper support unit 130 comes into contact with the upper part of the mixing container 10 in a form that wraps around a part of the periphery, and supports the mixing container 10 so that it can rotate around the first rotation axis A1 in the contact state.

In more detail, the upper support unit 130 mainly includes a pressing support unit 132 and a rotating roller unit 134, and the pressing support unit 132 is formed in an annular shape and is formed to protrude from one side face of the frame unit 110. In this case, the pressing support unit 132 is formed so that the upper part of the mixing container 10 is seated at the center, and is configured to wrap around a part of the peripheral around the first rotation axis A1.

In this embodiment, the pressing support unit 132 is formed in a semicircular annular shape with an open front as shown, and the upper end of the mixing container 10 is inserted into the open portion.

Here, the pressing support unit 132 is configured to elastically pressurize in the direction of the rotating support unit 120, and supports the mixing container 10 so as not to detach in a state of stably coming into contact with the rotating support unit 120.

The plurality of rotating roller units 134 are disposed to be spaced apart along the ring form of the pressing support unit 132 and comes into contact with the upper end of the mixing container 10.

The rotating roller unit 134 can be formed in the form of a normal roller or ball, and can rotate when the mixing container 10 rotates in a contact state at a certain angle corresponding to the shape of the region coming into contact with the mixing container 10.

In other words, the rotating roller unit 134 is provided between the pressing support unit 132 and the mixing container 10 and comes into contact with them, and when the mixing container 10 rotates around the first rotation axis A1, the pressing support unit 132 can stably maintain a pressed state without interference.

In this embodiment, the mixing container 10 is formed in a shape in which the periphery of the upper end decreases as shown, and correspondingly, the rotating roller unit 134 is disposed in a state of being inclined at a certain angle on the pressing support unit 132.

In this way, the guide module 100 according to the present invention includes the frame unit 110, the rotating support unit 120, and the upper support unit 130, and supports the mixing container 10 to be seated at a preset position and to be stably rotatable without being detached in the seated state.

Meanwhile, the rotating module 200 is provided on the guide module 100 and selectively rotates the mixing container 10 so that the first rotation axis A1 is formed along the vertical direction of the mixing container 10.

Specifically, the rotating module 200 is provided on the guide module 100 and configured to rotate the mixing container 10, and rotates the mixing container 10 while directly coming into contact with the mixing container 10, or is connected to the above-mentioned rotating support unit 120 and rotates the rotating support unit 120, so that the mixing container 10 can selectively rotate on the guide module 100.

In the present invention, the rotating module 200 rotates while coming into contact with the outer face of the mixing container 10, and rotates the mixing container 10. In this case, the rotating module 200 is installed in the frame unit 110 and rotates the mixing container 10 with a rotation axis parallel to the first rotation axis A1.

As shown in this embodiment, the mixing container 10 has a circular periphery on the side face, and the rotating module 200 is formed long along the longitudinal direction of the frame unit 110 and has a rotation axis parallel to the first rotation axis A1, and comes into contact with the side face of the mixing container 10 to rotate it.

As a result, the mixing container 10 rotates in the opposite direction around the first rotation axis A1 due to friction when the rotating module 200 rotates.

In more detail, the rotating module 200 mainly includes a driving unit 210 and a rotating unit 220, each of which has a similar outer shape and is disposed in parallel on the frame unit 110.

Here, the driving unit 210 and the rotating unit 220 are formed in roller types formed long along the longitudinal direction of the frame unit 110, and a plurality of units are disposed to be spaced apart along the width direction of the frame unit 110, and rotate together when the mixing container 10 rotates.

In this case, the rotating module 200 is made up of driving units 210 in which at least one of a plurality of units spaced apart along the width direction of the frame unit 100 selectively rotates to provide a rotational force, and the remaining unit except the driving units 210 is made up of a rotating unit 220 in a freely rotating state.

In this way, in the rotating module 200, a plurality of rollers are parallel to the first rotation axis A1, each of which comes into contact with the outer face of the mixing container 10, and any one of them is made up of the driving unit 210 which selectively rotates to provide power, thereby rotating the mixing container 10 around the first rotation axis A1.

Next, the tilting module 300 is configured to support the guide module 100 at a certain height and selectively tilt it.

Specifically, the tilting module 300 is formed long in the vertical direction, and is rotatably coupled to the guide module 100 on both sides along the width direction with the second rotation axis A2, and selectively rotates the guide module 100 in the vertical direction to tilt the mixing container 10 in the direction intersecting the first rotation axis A1.

In the present invention, the tilting module 300 is formed in a pair, and is supported on both sides along the width direction of the guide module 100, and each of them is coupled to a rotation shaft 114 formed on the bent part 112. In this case, the rotation shaft 114 forms the second rotation axis A2 and is configured to be rotatable by the tilting module 300.

In addition, separate rotation motors are built in the tilting module 300 to tilt the guide module 100 in the vertical direction. In this case, the tilting module 300 rotates back and forth along the vertical direction within a preset range of rotation angle.

In this way, as shown in FIG. 5, the tilting module 300 is configured to rotate the guide module 100 in the vertical direction, and by tilting the mixing container 10 seated to the guide module 100, the mixing container 10 rotates around the first rotation axis A1 and tilts to the second rotation axis A2 so that the contents inside can be mixed stably.

As described above, the mixing device according to the present invention includes the guide module 100, the rotating module 200, and the tilting module 300, and is configured to mix the contents by seating the mixing container 10 on the guide module 100 and by rotating the mixing container 2 in two directions by the rotating module 200 and the tilting module 300.

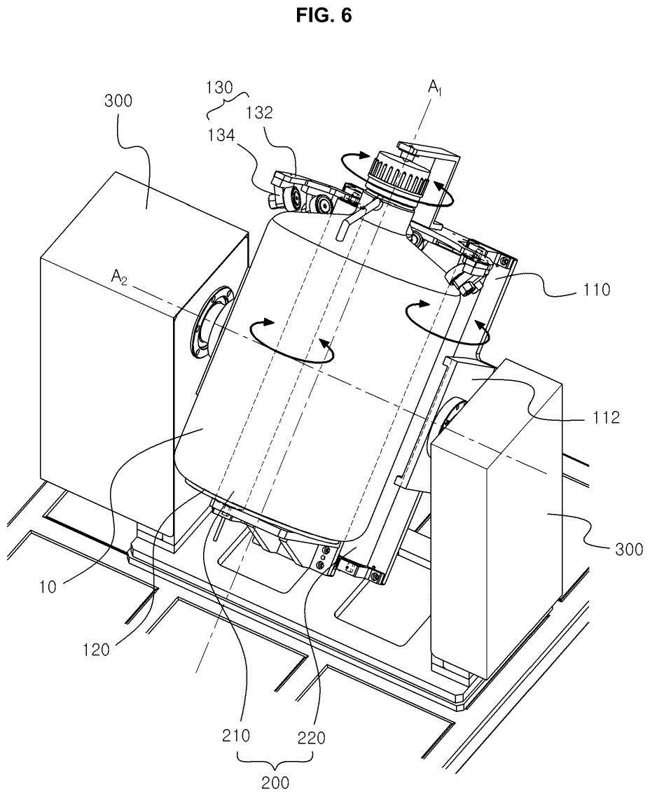

Next, referring to FIGS. 6 to 8, the operating state of the mixing device according to the present invention will be described below.

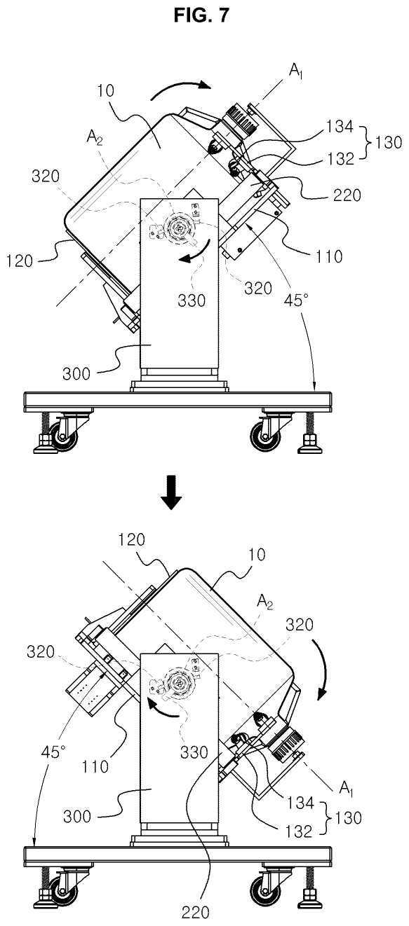

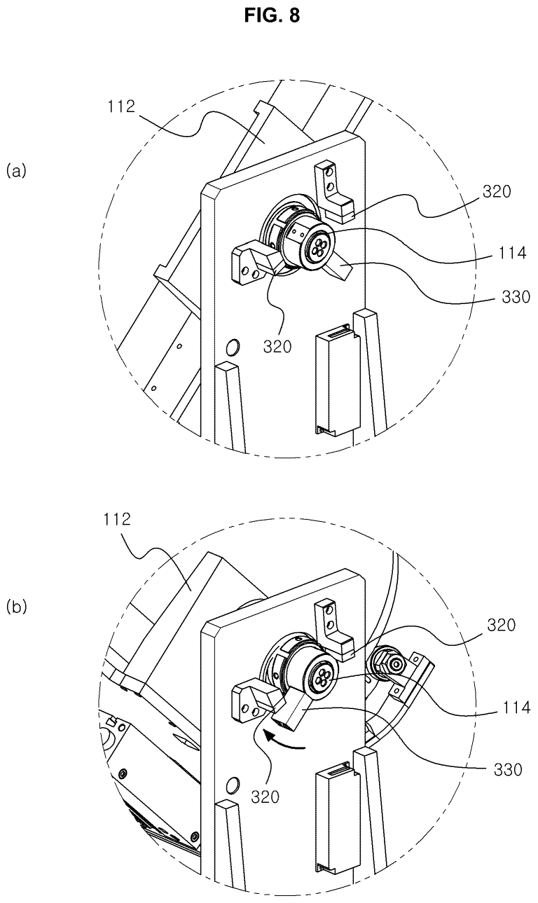

FIG. 6 is a diagram illustrating the state in which the rotating module 200 of the mixing device of FIG. 1 operates to rotate the mixing container 10, FIG. 7 is a diagram illustrating the state in which the guide module 100 of the mixing device of FIG. 1 tilts in the vertical direction, and FIG. 8 illustrates a limit stopper 320 inside the tilting module 320 in the mixing device of FIG. 1.

As described above, in the mixing device according to the present invention, the mixing container 10 is first seated to the guide module 100. In this case, it is preferable that the guide module 100 be seated in a vertically standing state as shown in FIG. 5, and the mixing container 10 is seated through the front open portion.

Here, the rotating support unit 120 and the upper support unit 130 are disposed in a spaced state corresponding to the vertical length of the mixing container 10, and the mixing container 10 is inserted and seated between them, thereby preventing unintentional detachment.

Furthermore, the upper support unit 130 has elasticity and is configured to be pressed toward the rotating support unit 120, so that the mixing container 10 can be more stably pressed when seated, and the mixing container 10 can be prevented from being detached.

After that, the guide module 100 rotates around the second rotation axis A2 by the tilting module 300 and rotates upward by a certain angle. Here, the rotating module 200 is driven together, and the mixing container 10 rotates around the first rotation axis A1 as shown in FIG. 6.

Next, the guide module 100 repeatedly tilts back and forth in the vertical direction within a preset range with the guide module 100 rotated by a certain angle as shown in FIG. 7.

That is, the mixing container 10 is rotated in the vertical direction by the tilting module 300 and rotated by the rotating module 200, so that the contents inside the mixing container 10 can be mixed.

Here, as described above, the tilting module 300 tilts upward by 135 degrees as shown in FIG. 5 after the mixing container 10 is seated with the guide module 100 disposed vertically, and then switched to the operation mode, and tilts about 90 degrees in the vertical direction in that position and repeatedly rotates in the vertical direction.

Accordingly, the mixing container 10 repeatedly tilts up and down within a range of 45 degrees each.

In this embodiment, the tilting module 300 may further include a separate limit stopper 320 that prevents the guide module 100 from rotating and detaching within a preset range, as shown in FIG. 8.

The at least one or more limit stoppers 320 are provided inside the tilting module 300, and is disposed at a preset position around the circumference centered on the second rotation axis A2.

Specifically, the limit stopper 320 comes into contact with a separate locking protrusion 330 protruding radially from the rotating shaft 114, and suppresses the rotating shaft 114 from rotating beyond a certain radius when rotating. As shown, the two limit stoppers 320 are disposed to be spaced apart around the second rotation axis A2, and are configured so that the locking protrusion 330 come into contact with them depending on the rotation angle of the rotating shaft 114.

Looking at FIG. 8(a), the guide module 100 is in an initial state and rotated at a certain angle, in such a case the locking protrusions 330 are disposed at a position not adjacent to the limit stopper 320, and no interference with the rotation occurs.

Looking at FIG. 8(b), when the guide module 100 rotates upward and rotates beyond a certain angle, the locking protrusions 330 are adjacent to or come into contact with the limit stopper 320 to suppress the rotation of the rotating shaft 114.

That is, at least one or more limit stoppers 320 are provided, and can prevent the guide module 100 from departing from a preset rotation angle range through interference and being restrained by interference when rotating, thereby preventing an occurrence of safety accident.

Meanwhile, the guide module 100 according to the present invention may further include a separate vibration generating unit (not shown) to increase the mixing effect of the contents when the mixing container 10 rotates and tilts.

The vibration generating unit is disposed adjacent to the mixing container in the guide module 100, and is configured to directly strike or generate vibration and transmit it to the inside of the mixing container 10, and the vibration generating unit applies impact to the mixing container 10 at regular intervals to generate vibration.

Accordingly, the mixing container 10 can increase the mixing speed when mixing the contents, thereby shortening the overall working time.

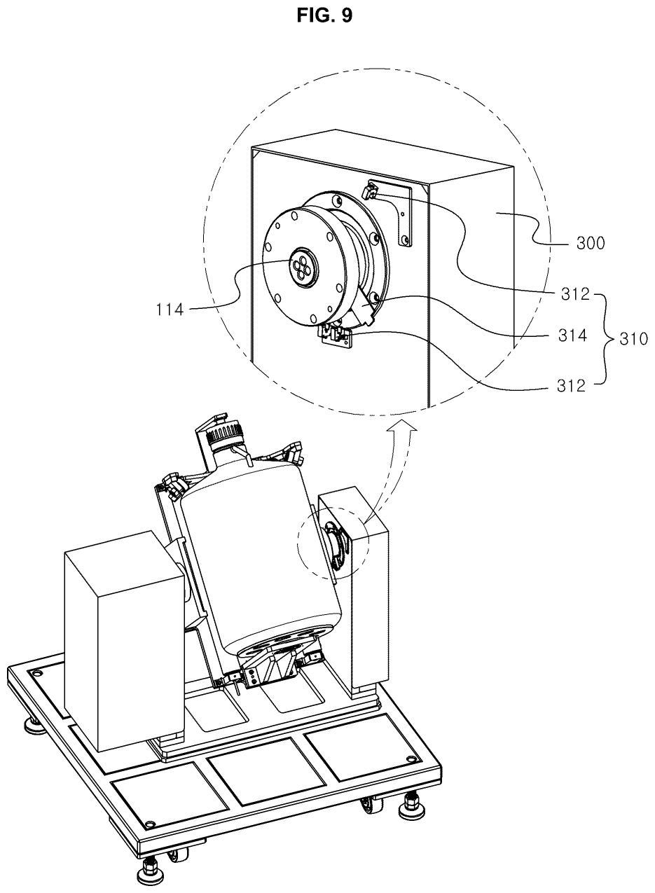

Next, a state in which the mixing device according to the present invention further includes a separate sensing unit 310 will be described below referring to FIG. 9.

FIG. 9 is a diagram illustrating the configuration of the sensing unit 310 in the mixing device of FIG. 1.

In the present invention, the tilting module 300 further includes a separate sensing unit 310 independent of the limit stopper 320 described above.

The sensing unit 310 is disposed adjacent to the second rotation axis A2 in the tilting module 300, and detects whether the guide module 100 rotates beyond a preset rotation angle when rotating, and stops the rotation when detecting this.

Specifically, the sensing unit is provided on at least one of both sides along the width direction of the guide module 100, and detects whether the rotation angle deviates from a preset range when the guide module 100 rotates around the second rotation axis A2.

Here, the sensing unit 310 includes a sensing part 312 disposed at a position adjacent to the second rotation axis A2 in the tilting module 300, and a separate rotation protrusion 314 provided on the rotation shaft 114, and it is detected whether the tilting angle of the guide module 100 deviates from the preset rotation angle depending on whether the rotation protrusion 314 is detected by the sensing part 312.

In more detail, at least one or more rotation protrusions 314 are provided, protrude to a certain length on the rotation shaft 114, and rotates together with the rotation shaft 114 when the rotation shaft 114 rotates to adjust the position.

The plurality of sensing parts 312 are disposed to be spaced apart along the circumference of the second rotation axis A2 in the tilting module 300, sense the position of the rotation protrusion 314, and detects whether it is within a preset rotation angle.

As shown in this embodiment, the rotation protrusion 314 is formed to protrude on the rotation shaft 114, and a plurality of sensing parts 312 are provided and disposed to be spaced apart from each other and disposed at the boundary portion of the rotation range of the rotation shaft 114.

In this way, the sensing unit 310 according to the present invention detects whether the guide module 100 tilts in the vertical direction within a preset rotation angle range, and if it deviates from this range, the sensing unit 310 can stop driving of the tilting module 300 to prevent an occurrence of safety accident.

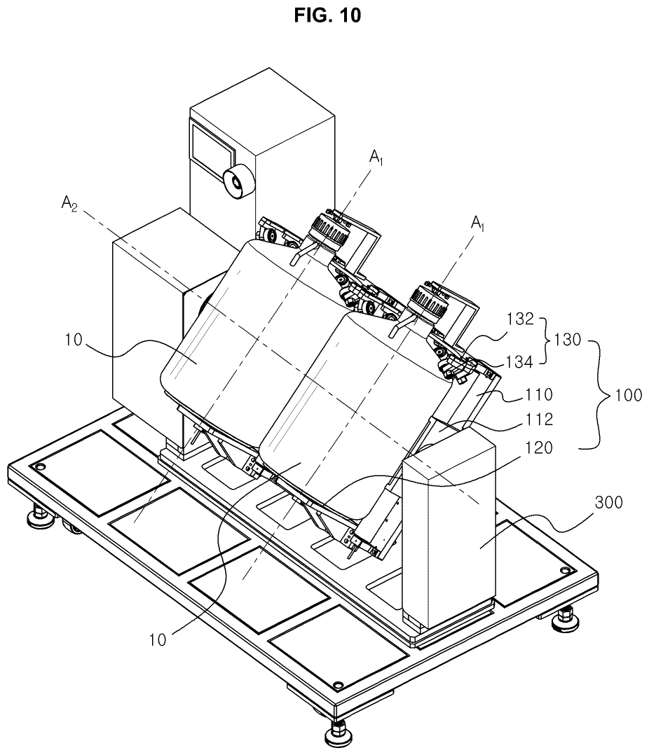

Next, a modified form of the mixing device according to the present invention will be described below referring to FIG. 10.

FIG. 10 is a diagram illustrating a state in which a plurality of guide modules 100 are configured in the mixing device according to the present invention.

As shown in the diagram, a basic configuration is similar to the above configuration, but a plurality of guide modules 100 are configured and disposed adjacent to each other along the second rotation axis A2.

The mixing container 10 is seated to each of the plurality of guide modules 100, so that the plurality of mixing containers 10 can be mixed simultaneously with one driving.

Specifically, a plurality of guide modules 100 are continuously provided along the second rotation axis A2 and are configured to be interconnected and be operable simultaneously, and each guide module 100 is independently provided with the rotating module 200.

Accordingly, the plurality of guide modules 100 and rotating modules 200 are each provided on one tilting module 300 to simultaneously mix the plurality of mixing containers 10, thereby mixing the contents faster and shortening the mixing time itself.

As a result, the mixing device according to the present invention includes the guide module 100 on which the mixing container 10 is seated, the rotating module 200 that rotates the mixing container 10, and the tilting module 300 that tilts the guide module 100 upward and downward, and there is an advantage that the occurrence of defects when mixing can be suppressed and at the same time the mixing time can be shortened, by rotating the mixing container 10 in two directions and mixing the contents.

Although the preferred embodiment of the present invention has been described above, it is obvious to those skilled in the art that the present invention can be embodied in other specific forms without departing from the spirit or category of the present invention. Therefore, the above-described embodiment should be considered as illustrative and not restrictive, and the present invention is not limited to the above description, and may be modified within the scope of the appended claims and their equivalents.

### Description of Symbols

10: Mixing container
100: Guide module
110: Frame unit
112: Bent part
114: Rotating shaft
120: Rotating support unit
130: Upper support unit
132: Pressing support unit
134: Rotating roller unit
200: Rotating module
210: Driving unit
220: Rotating unit
300: Tilting module
310: Sensing unit
312: Sensing part
314: Rotation protrusion
320: Limit stopper
330: Locking protrusion

What is claimed is:

1. A mixing device which rotates a mixing container that is formed long along a vertical direction and has a decreasing circumference at an upper end to mix contents contained therein, the mixing device comprising:
a guide module which has a preset length, to which the mixing container is rotatably seated along a longitudinal direction and to which the mixing container is selectively fixed to be attachable and detachable;
a rotating module which is provided on the guide module and selectively rotates the mixing container so that a first rotation axis is formed along the vertical direction of the mixing container; and
a tilting module which is formed long along the vertical direction, has a second rotation axis on both sides along a width direction of the guide module, is rotatably coupled, and selectively rotates the guide module in the vertical direction to tilt the mixing container in a direction intersecting the first rotation axis.

2. The mixing device according to claim 1,
wherein the guide module includes:
a frame unit that is formed long along the longitudinal direction of the mixing container with a preset length and that wraps a part of a side face of the mixing container;
a rotating support unit that is provided on the other end of the frame unit, and comes into contact with and supports a lower face of the mixing container; and
an upper support unit which is provided at one end of the frame unit, wraps a part of the circumference of the mixing container, and comes into contact with and supports an upper part along the longitudinal direction.

3. The mixing device according to claim 2,
wherein the upper support unit has elasticity in a direction of the rotating support unit and provides sliding application with a pressure of a certain level.

4. The mixing device according to claim 2,
wherein the rotating support unit is formed in a disk shape, provided on the other side of the frame unit, comes into contact with the lower face of the mixing container, and is coupled to be rotatable about the first rotation axis.

5. The mixing device according to claim 2,
wherein the upper support unit includes:
a pressing support unit which is formed in an annular shape, protrudes from one side face of the frame unit, and is formed so that the upper part of the mixing container is seated at a center; and
a plurality of rotating roller units which are disposed to be spaced apart along the annular shape of the pressing support unit, and come into contact with the upper end of the mixing container.

6. The mixing device according to claim 2,
wherein the rotating module is provided on the frame unit, has a rotation axis parallel to the first rotation axis, and rotates the mixing container.

7. The mixing device according to claim 6,
wherein the mixing container has a circular periphery on a side face, and
the rotating module is formed long along the longitudinal direction of the frame unit, has a rotation axis parallel to the first rotation axis, and comes into contact with the side face of the mixing container and rotates the mixing container.

8. The mixing device according to claim 7,
wherein the rotating module includes a plurality of driving units disposed to be spaced apart along the width direction of the frame unit, at least one of which selectively rotates to provide a rotational force, and a rotating unit in which the remaining unit except for the driving unit is in a free rotating state.

9. The mixing device according to claim 1,
wherein the tilting module rotates the guide module back and forth along the vertical direction within a preset range of rotation angles.

10. The mixing device according to claim 9,
wherein the tilting module includes a sensing unit which is provided on at least one of both sides along the width direction of the guide module, and detects whether the rotation angle deviates the preset range when the guide module rotates around the second rotation axis.

11. The mixing device according to claim 1,
wherein the guide module further includes a separate vibration generating unit that impacts the mixing container at regular intervals to generate vibrations.

12. The mixing device according to claim 1,
wherein the plurality of guide modules are provided continuously along the second rotation axis, interconnected, and configured to be operable simultaneously, and
the rotating module is provided independently for each guide module and the mixing container is seated.
